(19) United States
(12) Patent Application Publication
(10) Pub. No.: US 2020/0049730 A1
(43) Pub. Date: Feb. 13, 2020

(54) Recording system for evaluating and analyzing wind resources

(71) Applicant: Yongjun Shu, Jinhua City (CN)

(72) Inventor: Yongjun Shu, Jinhua City (CN)

(21) Appl. No.: 16/654,010

(22) Filed: Oct. 16, 2019

(30) Foreign Application Priority Data
May 15, 2019 (CL) 2019104038316

(51) Int. Cl. G01P 5/06; G01P 5/07

(52) U.S. Cl. CPC G01P 5/065; G01P 5/07

(57) ABSTRACT

A recording system for evaluating and analyzing wind resources includes centrifugal mechanism, which includes ring groove, curved block, vertical block, transmission plate and support block; quantitative mechanism, which includes output cavity, output shaft, arc bar, extension shaft and baffle; recording mechanism, which includes the third gear, the first magnet, counting plate and reading pointer; wind power utilization mechanism, which includes power generation shaft, fan blade, generator and power supply; the device is free to rise and fall, suitable for The terrain to be measured can automatically record the wind resources in the survey area, and convert the wind resources into electric energy, so that the user can record the data of wind resources in case of poor illumination, and the device is easy to read and operate. The user only needs to observe regularly.

### FIELD OF THE INVENTION

The present invention relates to a recording system for evaluating and analyzing wind resources.

### BACKGROUND OF THE INVENTION

Wind resource is a kind of clean energy and a kind of energy for sustainable development. It can be said that it is inexhaustible. Although wind energy is all over the country, the wind resource locations which can be used for power generation and other purposes need to be explored on the spot to draw a conclusion. The existing methods of wind resource assessment and analysis are more cumbersome, more labor-consuming, real-time observation, and there is no wind resource when measuring. Methods are used.

### SUMMARY OF THE INVENTION

The technical problem to be solved by the invention is to provide a recording system for evaluating and analyzing wind resources, which overcomes the disadvantages of tedious wind resource evaluation, human and time consumption, etc.

The invention is realized by the following technical scheme.

The invention relates to a wind resource evaluation and analysis recording system, which comprises a wind box, a lifting mechanism, a wind utilization mechanism, a centrifugal mechanism, a quantitative mechanism and a recording mechanism.

The air box is provided with a blowing groove, and the blowing groove is provided with a centrifugal mechanism, which comprises a ring groove, a curved block, a vertical block, a transmission plate and a support block, the support block is provided with a translation groove, the translation groove is provided with a translation block for sliding, the lower end face of the translation block is fixed with a translation spring which is fixedly connected with the lower end wall of the translation groove, and the translation The upper end face of the block is fixedly provided with a translation rod whose upper end is located in the blowing groove, the upper end of the translation rod is fixedly provided with the transmission plate, the circular groove is slidably provided with an arc block, the lower end face of the arc block is fixedly provided with the vertical block, the circular groove is slidably provided with the curved block, the right end face of the curved block is fixedly provided with a rack, and the upper and lower walls of the circular groove are symmetrically provided There are elastic grooves.

The quantitative mechanism comprises an output cavity, an output shaft, an arc rod, an extension shaft and a baffle, the output cavity is located in the upper end wall of the blowing groove, the rear end wall of the output cavity is rotationally provided with the output shaft and a positioning shaft, the output shaft is fixedly provided with a second gear, a thin inclined rod and the arc rod, the positioning shaft is fixedly provided with a inclined plate, and the lower end surface of the inclined plate is fixedly provided with the The back end wall of the output cavity is fixedly provided with a force block, the front end wall of the output cavity is rotationally provided with the extension shaft, the extension shaft is fixedly provided with a disc, the disc is fixedly provided with twelve short blocks, and the front end face of the disc is fixedly provided with twelve circular pillars.

Further, the recording mechanism comprises a third gear, a first magnet, a counting plate and a reading pointer. The rear wall of the output cavity is provided with a linkage groove. The rear end of the extension shaft is located in the linkage groove and is fixed with a first gear. The front wall of the linkage groove is fixed with a second magnet. The rear side of the second magnet absorbs the first magnet, and the rear end face of the first magnet rotates A recording shaft is movably provided, on the recording shaft is fixedly provided with the third gear and the reading pointer, the reading pointer is located at the rear side of the third gear, the third gear is meshed with the first gear for transmission, and the end wall of the circular groove is equipped with the counting plate.

Further, the wind power utilization mechanism comprises a power generation shaft, a fan blade, a generator and a power supply. The right end wall of the blowing groove is installed with the generator and the power supply. The generator is located at the lower side of the power supply. The generator and the power supply are connected by a first wire. The generator is installed with the power generation shaft, and the power generation shaft in the external space is uniformly fixed. There are four leaves, the right end face of the air box is equipped with a light box, and the light box is connected with the power supply through a second wire.

Further, the lifting mechanism comprises a support base, a lifting motor, a movable slot and a folding lifting sheet, the support base is located at the lower side of the bellows, the support base is provided with the movable slot, the left end wall of the movable slot is equipped with the lifting motor, the lifting motor is equipped with a threaded output shaft, and the threaded output shaft is connected with the sliding of the movable slot. The upper end face of the support seat is fixedly provided with a limited position block, the moving block and the limited position block are installed with the folding lifting sheet, and the upper end of the folding lifting sheet is installed with two mounting bases fixedly connected with the lower end face of the bellows.

Further, when the fan blades rotate, power can be generated through the generator, and the electric energy can be charged into the power supply for storage through the conduction of the first wire.

Further, when the arc block rotates along the annular groove, the left and right movement of the surface block can be pushed due to the shape of the surface block.

Further, the first magnet and the second magnet have magnetic force and are mutually adsorbed.

Further, the translation spring and the elastic spring are in a normal state. When the generating shaft rotates, the translation spring will be stretched under the centrifugal force.

The beneficial effect of the invention: the device can rise and fall freely, adapt to the terrain of the survey area, automatically record the wind resources of the survey area, and convert the wind resources into electric energy, so that the user can read and record the data of the wind resources when the light condition is poor, and the device reading and operation are convenient, the user only needs to observe regularly, which saves time.

### BRIEF DESCRIPTION OF THE DRAWINGS

For better explaining the technical proposal in the present invention embodiments or the prior art, the drawings to be used in the description of the embodiments or the prior art will be briefly described below.

FIG. 1 is an overall structural diagram of the recording system for evaluating and analyzing wind resources in this invention;

FIG. 2 is an enlarged schematic structural diagram of B in FIG. 1;

FIG. 3 is the schematic structural diagram of C in FIG. 1;

FIG. 4 is the schematic structural diagram along “A-A” direction in FIG. 1;

FIG. 5 is the schematic structural diagram of the surface block.

### DETAILED DESCRIPTION OF THE INVENTION

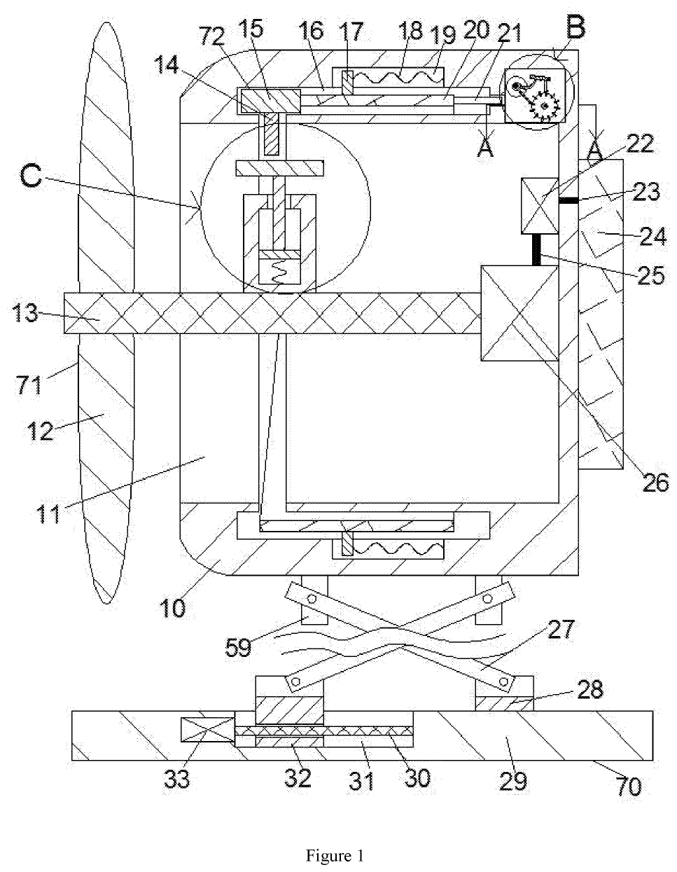

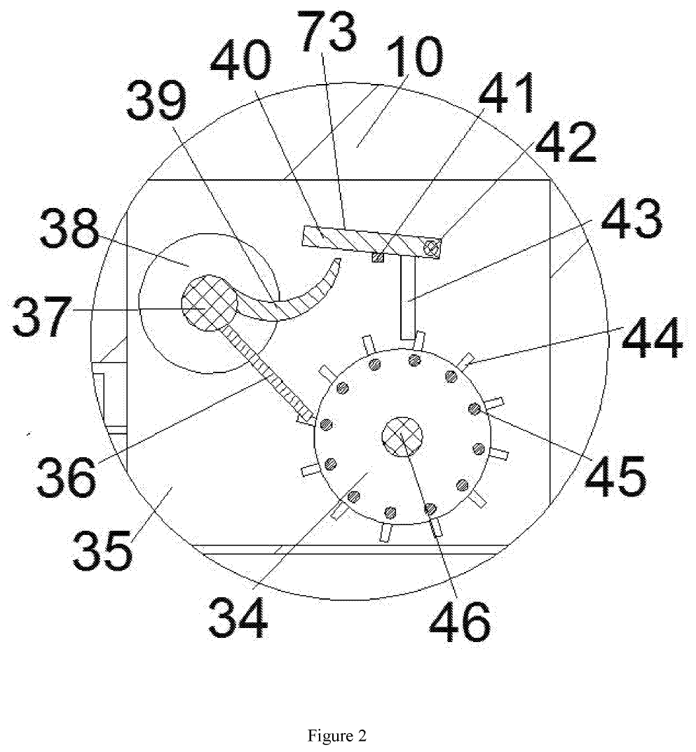

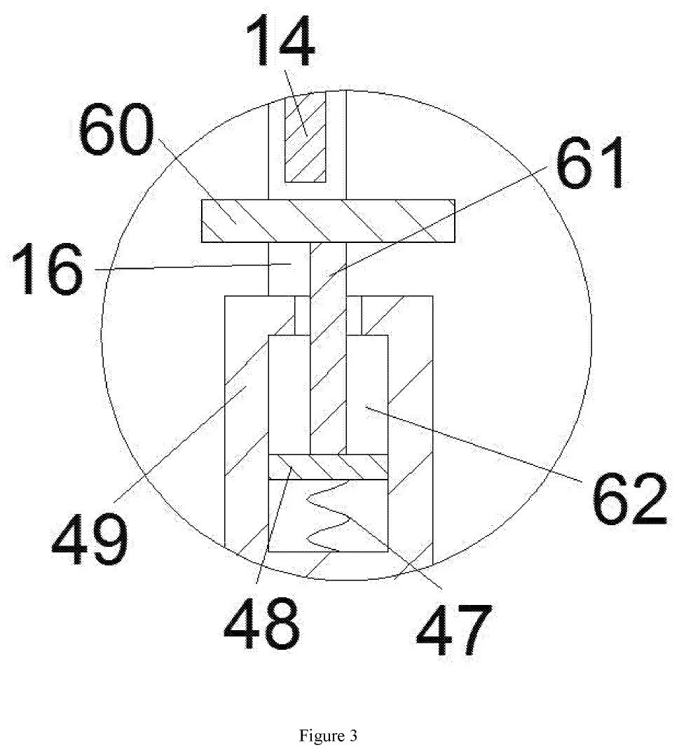

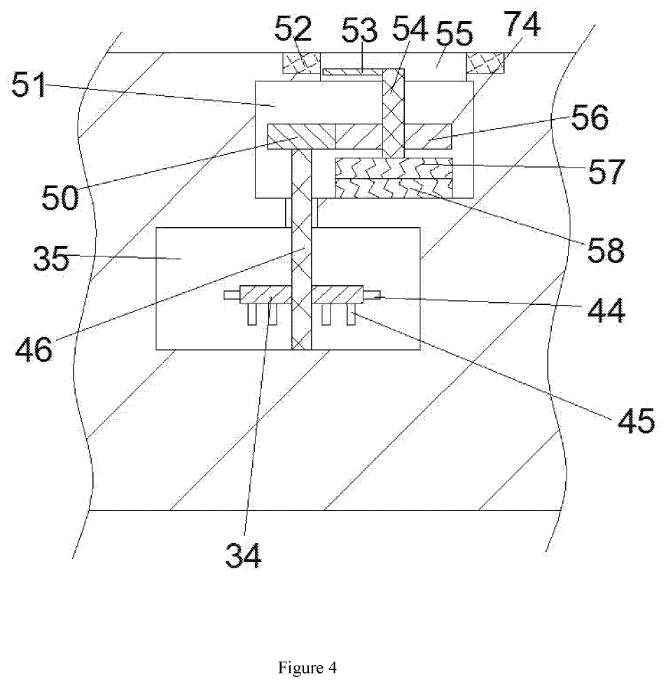

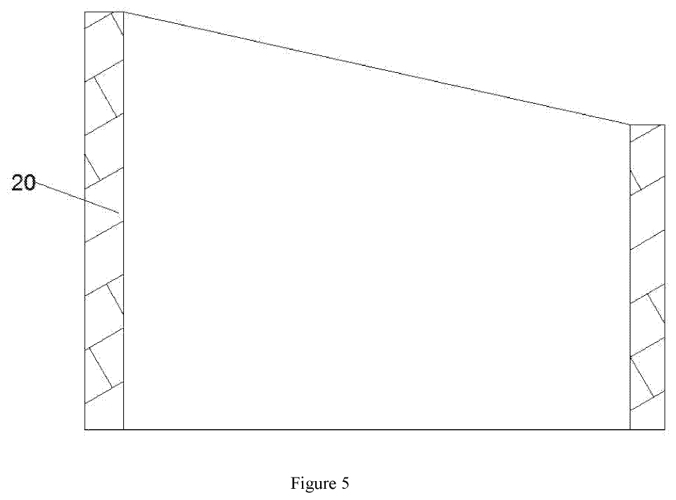

The invention will be described in detail below referring to FIGS. 1-5. For better explanation, the orientations described hereinafter are defined as follows: directions of up, down, left, right, front and rear in the text are identical to the directions of up, down, left, right, front and rear of FIG. 1.

Referring to FIGS. 1-5, a recording system for evaluating and analyzing wind resources mainly includes bellows 10, lifting mechanism 70, wind utilization mechanism 71, centrifugal mechanism 72, quantitative mechanism 73 and recording mechanism 74.

The air box 10 is provided with a blowing groove 11, and the blowing groove 11 is provided with a centrifugal mechanism 72, which comprises a ring groove 16, a curved block 20, a vertical block 14, a transmission plate 60 and a support block 49. The support block 49 is provided with a translation groove 62, the translation groove 62 is provided with a sliding block 48, and the lower end surface of the translation block 48 is fixed with a lower end which is fixedly connected with the lower end wall of the translation groove 62 The upper end face of the translation block 48 is fixed with the translation bar 61 whose upper end is located in the blowing groove 11, the upper end of the translation bar 61 is fixed with the transmission plate 60, the annular groove 16 is located in the end wall of the blowing groove 11, the annular groove 16 is sliding with the arc block 15, and the lower end face of the arc block 15 is fixed with the vertical one whose lower end is located in the blowing groove 11 The circular groove 16 is provided with the curved block 20, the right end face of the curved block 20 is fixed with the rack 21, the upper and lower walls of the circular groove 16 are symmetrically provided with the elastic groove 19, the right end wall of the elastic groove 19 is fixed with the elastic spring 18, the left end of the elastic spring 18 is fixed with the anti rotation block 17, one end close to the curved block 20 is fixedly connected with the curved block 20.

The quantitative mechanism 73 comprises an output cavity 35, an output shaft 37, an arc bar 39, an extension shaft 46 and a stop 43, the output cavity 35 is located in the upper end wall of the blowing groove 11, the rear end wall of the output cavity 35 is rotationally provided with the output shaft 37 and the positioning shaft 42, the positioning shaft 42 is located on the right side of the output shaft 37, and the output shaft 37 is fixedly provided with a second gear 38, a thin diagonal bar 36 and the arc bar 39 The thin diagonal rod 36 and the arc rod 39 are located at the front side of the second gear 38, the positioning shaft 42 is fixedly provided with a diagonal plate 40, the lower end face of the diagonal plate 40 is fixedly provided with the baffle 43, the rear wall of the output cavity 35 is fixedly provided with a force bearing block 41, the front wall of the output cavity 35 is rotationally provided with the extension shaft 46, the extension shaft 46 is fixedly provided with a disc 34, and the disc 34 is uniformly fixed Twelve short blocks 44 are fixed, and the front end face of the disc 34 is uniformly fixed with twelve cylinders 45.

The recording mechanism 74 comprises a third gear 56, a first magnet 57, a counting plate 52 and a reading pointer 53. The rear wall of the output cavity 35 is provided with a linkage groove 51, which is communicated with the external space through a circular groove 55. The rear end of the extension shaft 46 is located in the linkage groove 51 and is fixedly provided with a first gear 50. The front wall of the linkage groove 51 is fixedly provided with a second magnet 58 and the second magnet 58 the rear side of the first magnet 57 is adsorbed with the first magnet 57, the rear end face of the first magnet 57 is rotated with the recording shaft 54, the third gear 56 and the reading pointer 53 are fixed on the recording shaft 54, the reading pointer 53 is located at the rear side of the third gear 56, the third gear 56 is meshed with the first gear 50 for transmission, and the end wall of the circular groove 55 is installed with the counting plate 52.

The wind power utilization mechanism 71 comprises a generator shaft 13, a fan blade 12, a generator 26 and a power supply 22. The generator 26 and the power supply 22 are installed on the right end wall of the blowing trough 11. The generator 26 is located at the lower side of the power supply 22. The generator 26 and the power supply 22 are connected through the first wire 25. The generator 26 is equipped with the power shaft 13 whose left end is located in the outer space. Four leaves 12 are uniformly fixed on the generator shaft 13 in the external space, and a light box 24 is installed on the right end face of the air box 10. The light box 24 is connected with the power supply 22 through the second wire 23.

The lifting mechanism 70 comprises a support seat 29, a lifting motor 33, a movable groove 31 and a folding lifting plate 27, the support seat 29 is located at the lower side of the bellows 10, the support seat 29 is provided with the movable groove 31 with an opening facing upwards, the left end wall of the movable groove 31 is installed with the lifting motor 33, and the right end of the lifting motor 33 is installed with a thread which is rotationally connected with the right end wall of the movable groove 31 The output shaft 30 is threaded with a moving block 32 which is slidably connected with the movable groove 31. The upper end face of the support seat 29 is fixed with a limit block 28, which is located on the right side of the moving block 32. The moving block 32 and the limit block 28 are installed with the folding lifting plate 27. The upper end of the folding lifting plate 27 is installed with two lower ends of the bellows 10 The mounting base 59 of the face fixed connection.

When the fan blade 12 rotates, power can be generated through the generator 26, and the electric energy can be charged into the power source 22 for storage through the conduction of the first wire 25.

When the arc block 15 rotates along the annular groove 16, the arc block 20 can be pushed to move about due to the shape of the arc block 20.

The first magnet 57 and the second magnet 58 have magnetic force and are mutually adsorbed.

The translation spring 47 and the elastic spring 18 are in a normal state. When the generating shaft 13 rotates, the translation spring 47 will be stretched under the centrifugal force.

### Mechanical Action Sequence of the Whole Device

Place the device where the wind resource assessment needs to be carried out, and face the fan blade 12 in the direction of the wind.

Start the lifting motor 33, drive the threaded output shaft 30 to rotate, through the threaded connection between the threaded output shaft 30 and the motion block 32, drive the movement of the motion block 32, thereby driving the movement of the folding lifting plate 27, making the bellows 10 lift, so that the device is not blocked by obstacles.

The wind drives the fan blade 12 to rotate, thus driving the generator shaft 13 to rotate. The generator shaft 13 rotates to generate electricity through the generator 26. The electric energy is stored in the power supply 22 through the conduction of the first wire 25.

The generator shaft 13 drives the transmission plate 60 to rotate, and under the action of centrifugation, stretches the translation spring 47, and the transmission plate 60 moves away from the generator shaft 13.

When the wind force reaches the expected standard, the transmission plate 60 moves to the position of the vertical block 14, pushing the vertical block 14 to move, and the vertical block 14 drives the arc block 15 to move in the circular groove 16.

The arc block 15 moves, pushing the surface block 20 to move, the surface block 20 drives the rack 21 to move to the right to engage with the second gear 38, driving the second gear 38 to rotate, the second gear 38 drives the arc bar 39 to rotate with the thin diagonal bar 36, the arc bar 39 pushes the inclined plate 40, making the stop 43 move to the left, the arc bar 39 and the thin diagonal bar 36 continue to move, the thin diagonal bar 36 against the cylinder 45, making the disc 34 rotate at a certain angle Degree, the disc 34 drives the extension shaft 46 to rotate.

Through the meshing transmission of the first gear 50 and the third gear 56, the recording shaft 54 is driven to rotate, thus driving the reading pointer 53 to rotate at a certain angle, which makes the reading of the reading pointer 53 change once in the reading of the counting board 52.

Observe and record the readings of counter 52 one day later, and analyze the readings one week in a row to get the data of local wind resources.

When the light conditions are not good, the power supply 22 is started, and the light box 24 can be made to emit light through the conduction of the second wire 23.

After one recording, take out the recording shaft 54, rotate it to reset, and then record again.

The above is only the specific embodiment of the present invention, but the protection scope of the present invention is not limited thereto, and any changes or substitutions without creative efforts shall fall within the protection scope of the present invention. Therefore, the claimed protection extent of the invention shall be determined with reference to the appended claims.

1. A recording system for evaluating and analyzing wind resources, comprising:
a wind box,
a lifting mechanism,
a wind utilization mechanism,
a centrifugal mechanism, a quantitative mechanism and a recording mechanism;
the air box is provided with a blowing groove,
and the blowing groove is provided with a centrifugal mechanism, which comprises a ring groove, a curved block, a vertical block, a transmission plate and a support block,
and the support block is provided with a translation groove,
and the translation groove is provided with a translation block for sliding,
and the lower end face of the translation block is fixed with a translation spring which is fixedly connected with the lower end wall of the translation groove,
and the translation the upper end face of the block is fixedly provided with a translation rod whose upper end is located in the blowing groove,
and the upper end of the translation rod is fixedly provided with the transmission plate,
and the circular groove is slidably provided with an arc block,
and the lower end face of the arc block is fixedly provided with the vertical block,
the circular groove is slidably provided with the curved block,
the right end face of the curved block is fixedly provided with a rack,
and the upper and lower walls of the circular groove are symmetrically provided there are elastic grooves;
the quantitative mechanism comprises an output cavity, an output shaft, an arc rod, an extension shaft and a baffle,
the output cavity is located in the upper end wall of the blowing groove,
the rear end wall of the output cavity is rotationally provided with the output shaft and a positioning shaft,
the output shaft is fixedly provided with a second gear,
a thin inclined rod and the arc rod, the positioning shaft is fixedly provided with a inclined plate,
and the lower end surface of the inclined plate is fixedly provided with the inclined plate,
the back end wall of the output cavity is fixedly provided with a force block,
the front end wall of the output cavity is rotationally provided with the extension shaft,
the extension shaft is fixedly provided with a disc,
the disc is fixedly provided with 12 short blocks evenly, and the front end face of the disc is fixedly provided with 12 cylinders evenly.

2. The recording system for evaluating and analyzing wind resources of claim 1, wherein
the recording mechanism comprises a third gear, a first magnet, a counting plate and a reading pointer,
and the rear wall of the output cavity is provided with a linkage groove,
and the rear end of the extension shaft is located in the linkage groove and is fixed with a first gear,
and the front wall of the linkage groove is fixed with a second magnet,
and the rear side of the second magnet absorbs the first magnet,
and the rear end surface of the first magnet rotates and is provided with a record,
and the recording shaft is fixedly provided with the third gear and the reading pointer,
the reading pointer is located at the rear side of the third gear,
the third gear and the first gear are meshed and driven,
and the end wall of the circular groove is installed with the counting plate.

3. The recording system for evaluating and analyzing wind resources according to claim 1, which is characterized in that the wind utilization mechanism comprises a generator shaft, a fan blade, a generator and a power supply,
the right end wall of the blowing trough is installed with the generator and the power supply,
the generator is located at the lower side of the power supply,
the generator and the power supply are connected through the first wire,
and the generator the power generation shaft is installed,
four leaves are uniformly fixed on the power generation shaft in the external space,
the right end face of the air box is installed with a light box,
and the light box and the power supply are connected through a second wire.

4. The recording system for evaluating and analyzing wind resources according to claim 1, wherein the lifting mechanism comprises a support seat, a lifting motor, a movable slot and a folding lifting plate,
the support seat is located at the lower side of the air box, the support seat is provided with the movable slot,
the left end wall of the movable slot is provided with the lifting motor,
and the lifting motor is provided with a thread the output shaft is threaded with a moving block which is slidably connected with the movable groove,
the upper end face of the support seat is fixed with a limited block,
the moving block and the limited block are installed with the folding lifting piece,
and the upper end of the folding lifting piece is installed with two mounting bases which are fixedly connected with the lower end face of the bellows.

5. The recording system for evaluating and analyzing wind resources according to claim 1 or claim 3, which is characterized in that when the fan blade rotates, power can be generated through the generator,
and the electric energy can be charged into the power supply for storage through the conduction of the first wire.

6. The recording system for evaluating and analyzing wind resources according to claim 1, which is characterized in that when the arc block rotates along the annular groove, the left and right movements of the surface block can be pushed due to the shape of the surface block.

7. The recording system for evaluating and analyzing wind resources according to claim 1 or 2, which is characterized in that the first magnet and the second magnet have magnetic force and are mutually adsorbed.

8. The recording system for evaluating and analyzing wind resources according to claim 1, which is characterized in that the translation spring and the elastic spring are in a normal state, and when the power generation shaft rotates, the translation spring will be stretched under the centrifugal force.
